(19) United States
(12) Patent Application Publication
(10) Pub. No.: US 2023/0229716 A1
(43) Pub. Date: Jul. 20, 2023

(54) SYSTEM AND METHOD OF TOKENIZING PATENTS

(71) Applicants: ERICH LAWSON SPANGENBERG, PARIS (FR); DANIEL LAWRENCE BORK, EAST KINGSTON, NH (US); PASCAL ASSELOT, PARIS (FR)

(72) Inventors: ERICH LAWSON SPANGENBERG, PARIS (FR); DANIEL LAWRENCE BORK, EAST KINGSTON, NH (US); PASCAL ASSELOT, PARIS (FR)

(21) Appl. No.: 18/072,628

(22) Filed: Nov. 30, 2022

Related U.S. Application Data
(63) Continuation of application No. 16/435,532, filed on Jun. 9, 2019, now abandoned.
Application No. 16/435,532 is a continuation of application No. 16/216,776, filed on Dec. 11, 2018, now abandoned.
Application No. 16/216,776 is a continuation of application No. 16/257,006, filed on Jan. 24, 2019, now abandoned.
Application No. 16/257,006 is a continuation of application No. 16/384,524, filed on Apr. 15, 2019, now abandoned.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.

(30) Foreign Application Priority Data
Oct. 22, 2018 (WO) PCT/US18/56884
Oct. 23, 2018 (WO) PCT/US18/57062
Nov. 5, 2018 (WO) PCT/US18/59174
Nov. 16, 2018 (WO) PCT/US18/61448
Dec. 6, 2018 (WO) PCT/US18/64186

(51) Int. Cl. G06F 16/953; G06F 16/93; G06F 16/2457; G06Q 50/18

(52) U.S. Cl. CPC G06F 16/953; G06F 16/93; G06F 16/24578; G06Q 50/184; G06F 2216/11

(57) ABSTRACT

We are tokenizing patent ownership. This opens up transactions that simply are not possible today. The special purpose vehicle (SPV) is like a ‘trust’ that exists to hold and execute the patent transactions on the owner side without the owner being involved. The smart contract has self-executing elements and handles trust issues. The invention utilizes artificial intelligence (AI).

### PRIORITY CLAIMS

This application is a continuation of U.S. patent application Ser. No. 16/435,532, filed Jun. 9, 2019, which claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018. This application also claims the benefit of International Patent Application Number PCT/US2018/56884, filed on Oct. 22, 2018. This application also claims the benefit of International Patent Application No. PCT/US2018/57062, filed on Oct. 23, 2018. This application also claims the benefit of International Patent Application Number PCT/US2018/59174, filed on Nov. 5, 2018. This application also claims the benefit of International Patent Application Number PCT/US2018/61448, filed on Nov. 16, 2018. This application also claims the benefit of International Patent Application Number PCT/US2018/64186, filed on Dec. 6, 2018. This application also claims the benefit of U.S. patent application Ser. No. 16/216,776, filed Dec. 11, 2018. This application also claims the benefit of U.S. patent application Ser. No. 16/257,006, filed Jan. 24, 2019. This application also claims the benefit of U.S. patent application Ser. No. 16/384,524, filed Apr. 15, 2019, each of which is incorporated herein by reference.

### BACKGROUND OF THE INVENTION

This invention deals with patent ownership. The problem is the current patent ownership system has limitations and drawbacks. The social bargain supporting patents is simple: promote disclosure to permit others to build on your technology. You disclose your novel invention and for that disclosure you are given exclusive rights for 20 years from the application filing date.

Patents are often analogized to real estate, and indeed there are many similarities. The owner of a patent has a right to exclude unauthorized users of the invention, just as the owner of property has the right to exclude trespassers. National patent offices are supposed to contain records that provide notice of patent ownership and the scope of the owner's intellectual property, just as public filings are supposed to memorialize who owns a parcel of real estate while defining its metes and bounds. Searching national databases to identify patents and patent owners is critically important for millions of annual users in order to determine: (1) if a patent exists on particular technology; (2) who owns a particular patent that you may have discovered; (3) clean chain of title in every transaction where a patent is involved, including when a patent is bought, sold, licensed or part of a financed either in an independent transaction or as part of a larger corporate transaction; (4) true patent ownership in every lawsuit to ensure that the party asserting infringement has the right to do so; and (5) who to contact in order to obtain a license or acquire patented technology. The concept of patents has existed for thousands of years and the legal frameworks to support patents have existed since the fifteenth century. Today, there are about 20 million patents globally that are granted by over 200 independent national patent offices that exist in each country that grants patents.

Patents are a critically important asset class supporting $2 trillion in annual global R&D spending. Governments spend billions of dollars per year on patent regulation on top of the billions spent to promote innovation. Inventors and patent owners spend billions of dollars per year on seeking, filing, obtaining, maintaining and analyzing patents. The asset class is often delegated to the wrong asset managers. An organized patent market does not exist today—the “market” consists of a series of one off transactions. The overall market is characterized by a lack of transparency, incredible inefficiency and staggering intermediary and transactional costs that depress transaction volumes and represents significant costs and lost benefit to society. Intermediary functions—like payment of fees to maintain a patent in effect and royalty processing services—are extremely high and simply add billions to the cost of owning, maintaining and utilizing a patent.

### SUMMARY OF THE INVENTION

We are tokenizing patents. We are tokenizing patent ownership. This opens up transactions that simply are not possible today. The special purpose vehicle (SPV) is like a ‘trust’ that exists to hold and execute the patent transactions on the owner side without the owner being involved. The smart contract has self-executing elements and handles trust issues. The invention utilizes artificial intelligence (AI). We are tokenizing patent-based lending. We are tokenizing patent monetization.

The present invention features a Global Patent Registry, which is a blockchain-enabled registry that is a freely accessible record of the world's patents and their owners. There is no single accurate central database of all of the world's 20 million patents. There are −200 national patent offices, one for each country with patents, and 10 regional patent offices with different rules and procedures. Many of these databases for individual counties, including the USPTO PAIR system for US patents, require special credentials to access. Even Google Patents only covers 23 national patent offices. Determining patent ownership is difficult and expensive, not all patent offices even track ownership information and those that do (the US, for example) have error rates in patent ownership estimated at over 30%. There is no Standard Industrial Classification (SIC) or similar code for patent owners—the same company may hold patents in multiple subsidiary names and never identify the parent entity. The current process of verifying patent ownership is prohibitively expensive, often requiring the assistance of legal counsel to navigate complicated records. These high costs and error rates are depressing transaction volumes and reducing the value of patents because the simple tasks of identifying a patent and its owner are expensive and complex.

Utilizing blockchain solutions, we are able to use the Global Patent Registry to create a single, freely accessible record of the world's patents and who owns them. There are three levels of verification: patent ownership as indicated by the records obtained from the national patent offices; patent ownership based on the records obtained from the national patent offices as confirmed by predictive analytics solutions; and patent ownership based on analysis as confirmed by the patent owner and owner verification.

The present invention also features an AI powered patent analytics tool to determine whether a patent exists in a particular technology area and what specific aspect of the technology the patent covers is expensive and complicated and traditionally requires extensive and expensive intermediary involvement. Important issues like validity and relevancy are quickly and efficiently performed by the analytics engine. Utilizing artificial intelligence and sophisticated database management methods the analytics engine can offer answers about patents in a quick, efficient and inexpensive manner, including patent valuation through establishing a value (transfer pricing) for a particular patent.

The present invention can accommodate everything from simple to highly complex transactions and facilitate various other engagements and transactions relevant to the patent ecosystem. Much of the problem today is that it is simply complicated, expensive and difficult to transact patents. Intermediary costs are extremely high and transactions are difficult to execute. As a result, smaller transactions are simply not economically viable and, therefore, do not occur. Even larger value transaction volumes are depressed as a result of these costs and inefficiencies. A target opportunity for the IPwe Platform is the facilitate transactions with respect to lower value patents that previously were unlikely to transact as the associated intermediary costs rendered such transactions not economically viable. Most of the world's patents are efficiently priced at lower values.

Paying a maintenance fee (the typical annual fee a patent office charges to keep a patent in effect) is expensive and complicated. One of the early revenue opportunities is to use the present invention to massively reduce patent maintenance fee costs patent offices want to encourage the payment of maintenance fees, and patent owners want a less expensive solution. Royalty administration, monitoring and financing are expensive and blockchain will have significant implications in terms of accuracy and lower costs. The present invention is able to handle traditional patent transactions, including but not limited to: licensing; acquisition and disposition; annuity payments; royalty administration and monitoring; pooling; and commercialization. Solving these problems will facilitate traditional transactions and encourage new transaction opportunities by addressing significant issues that will broadly benefit multiple participants in the global patent ecosystem.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an illustration depicting an exemplary operating environment including one or more user computers, computing devices, or processing devices, which can be used to operate a client, such as a dedicated application, web browser is shown.

FIG. 2 is another illustration depicting an exemplary operating environment including a computer system with various elements as shown.

FIG. 3 is an illustration of one aspect of the present invention.

FIG. 4 is a diagram of the overall infrastructure of the present invention.

FIG. 5 is a diagram of the patent grant process of the present invention.

FIG. 6 is a diagram of the patent sale assignment process of the present invention.

FIG. 7 is a diagram of the patent license agreement process of the present invention.

FIG. 8 is a diagram of the patent pool process of the present invention.

FIG. 9 is a diagram of the patent-based lending process of the present invention.

FIG. 10 is a diagram of the tokenized patent-based lending process of the present invention.

FIG. 11 is a diagram of the tokenized patent monetization process of the present invention.

FIG. 12 is a diagram of the defensive aggregation process of the present invention.

FIG. 13 is a diagram of the mutual non-aggression pact process of the present invention.

FIG. 14 is a diagram of the patent grant process of the present invention incorporating blockchain technology.

FIG. 15 is a diagram of the patent assignment process of the present invention incorporating blockchain technology.

### DETAILED DESCRIPTION OF THE PREFERRED EMBODIMENT

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

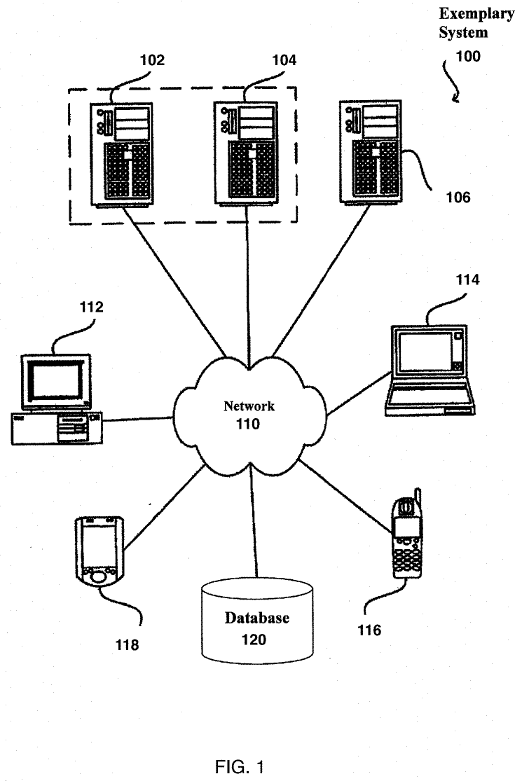

FIG. 1 is a block diagram illustrating components of an exemplary operating environment in which embodiments of the present invention may be implemented. The system 100 can include one or more user computers, computing devices, or processing devices 112, 114, 116, 118, which can be used to operate a client, such as a dedicated application, web browser, etc. The user computers 112, 114, 116, 118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 112, 114, 116, 118 may also have any of a variety of applications, including one or more development systems, database client and/or server applications, and Web browser applications. Alternatively, the user computers 112, 114, 116, 118 may be any other electronic device, such as a thin-client computer, Internet-enabled gaming system, and/or personal messaging device, capable of communicating via a network (e.g., the network 110 described below) and/or displaying and navigating Web pages or other types of electronic documents. Although the exemplary system 100 is shown with four user computers, any number of user computers may be supported.

In most embodiments, the system 100 includes some type of network 110. The network can be any type of network familiar to those skilled in the art that can support data communications using any of a variety of commercially-available protocols, including without limitation TCP/IP, SNA, IPX, AppleTalk, and the like. Merely by way of example, the network 110 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 102, 104, 106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 106) may be dedicated to running applications, such as a business application, a Web server, application server, etc. Such servers may be used to process requests from user computers 112, 114, 116, 118. The applications can also include any number of applications for controlling access to resources of the servers 102, 104, 106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 112, 114, 116, 118. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 112, 114, 116, 118.

The system 100 may also include one or more databases 120. The database(s) 120 may reside in a variety of locations. By way of example, a database 120 may reside on a storage medium local to (and/or resident in) one or more of the computers 102, 104, 106, 112, 114, 116, 118. Alternatively, it may be remote from any or all of the computers 102, 104, 106, 112, 114, 116, 118, and/or in communication (e.g., via the network 110) with one or more of these. In a particular set of embodiments, the database 120 may reside in a storage-area network (“SAN”) familiar to those skilled in the art. Similarly, any necessary files for performing the functions attributed to the computers 102, 104, 106, 112, 114, 116, 118 may be stored locally on the respective computer and/or remotely, as appropriate. In one set of embodiments, the database 120 may be a relational database, such as Oracle 10g, that is adapted to store, update, and retrieve data in response to SQL-formatted commands.

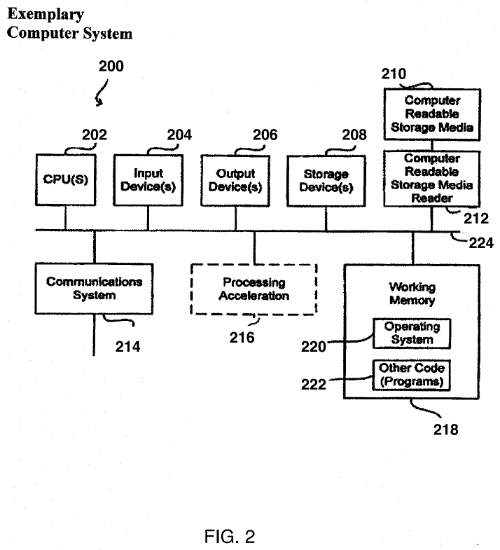

FIG. 2 illustrates an exemplary computer system 200, in which embodiments of the present invention may be implemented. The system 200 may be used to implement any of the computer systems described above. The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like. The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 2 further illustrates an environment where an on-demand distributed database service might be used. As illustrated in FIG. 2 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third-party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

In one embodiment, the present invention contains a method of transactions wherein all fees, payments, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

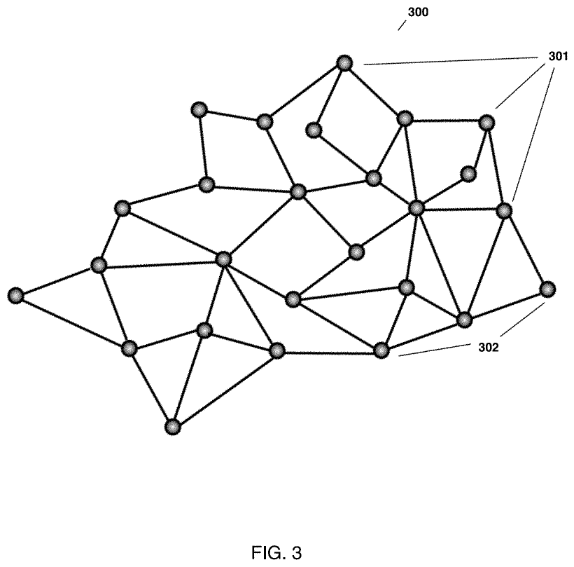

FIG. 3 depicts one aspect of the present invention. Specifically, the illustration shows the interconnection of each node 301 in a distributed decentralized network 300. In accordance with the preferred embodiment of the present invention, each node 301 in the distributed network 300 is directly connected to at least two other nodes 302. This allows each node 301 to transact with at least one other node 301 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

The above illustrations provide many different embodiments for implementing different features of the invention. Specific embodiments of components and processes are described to help clarify the invention. These are, of course, merely embodiments and are not intended to limit the invention from that described in the claims. In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources. A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices. The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

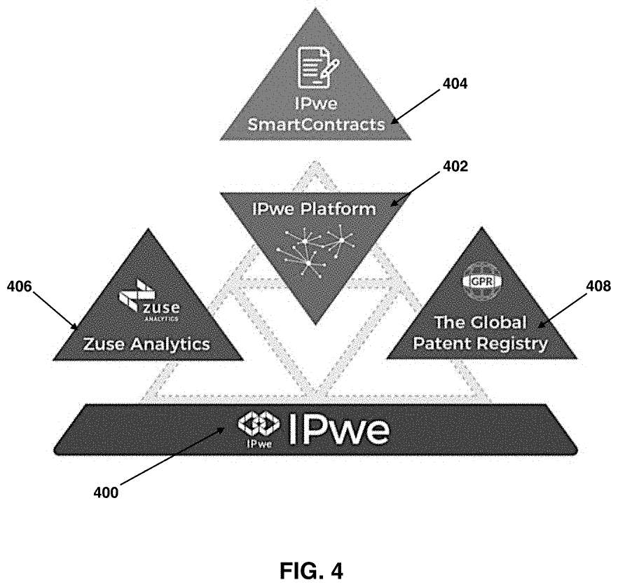

FIG. 4 is a diagram of the overall infrastructure of the present invention. In accordance with the preferred embodiment of the present invention, the overall infrastructure of the present invention 400 has the ability to use Artificial Intelligence (AI) and blockchain to enable the patent asset class. The infrastructure 400 encompasses four main components: the IP platform 402; SmartContracts 404; the analytics engine 406; and the Global Patent Registry 408. The platform embodiment 402 of the present invention 400 is an operational blockchain-powered transactional platform that can provide everything that the patent ecosystem needs to maintain and transact in patents, including but not limited to: acquisitions; defensive aggregation; financing; insurance; lending; licensing; maintenance fees; mutual non-aggression pooling; sales; tokenization; and other transactions. The SmartContracts embodiment 404 of the present invention 400 is designed and implemented on hyperledger by the world's leading experts on patent transactions. The analytics embodiment 406 of the present invention 400 leverages the power of AI to provide detailed answers to a wide range of questions concerning patents. The Global Patent Registry embodiment 408 of the present invention 400 is a blockchain enabled registry of all patents available worldwide, and is able to provide full transparency in patent identification and ownership.

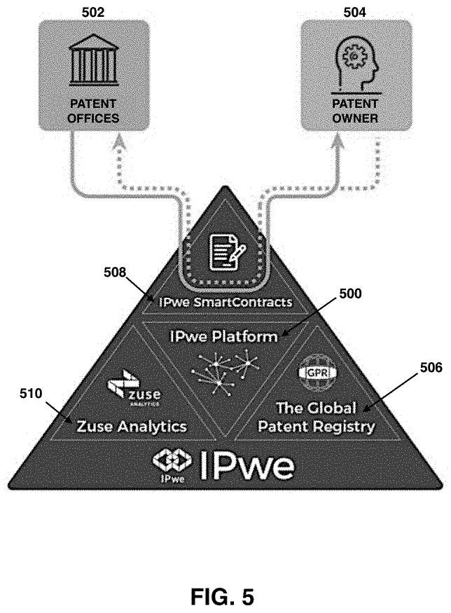

FIG. 5 is a diagram of how payment annuities are facilitated using the present invention. In accordance with the preferred embodiment of the present invention 500, once the patent office 502 has granted a patent to a patent owner 504, the global patent registry 506 is updated and the patent owner 504 pays the annuity fee to the patent office 502. The smart contracts embodiment 508 of the present invention 500 is then used for identification of patents and patent owners as well as the payment of annuities. The present invention 100 updates the global patent registry 506 and subsequently handles all analytics 510, annuity payments and patent contracts on behalf of the patent owner.

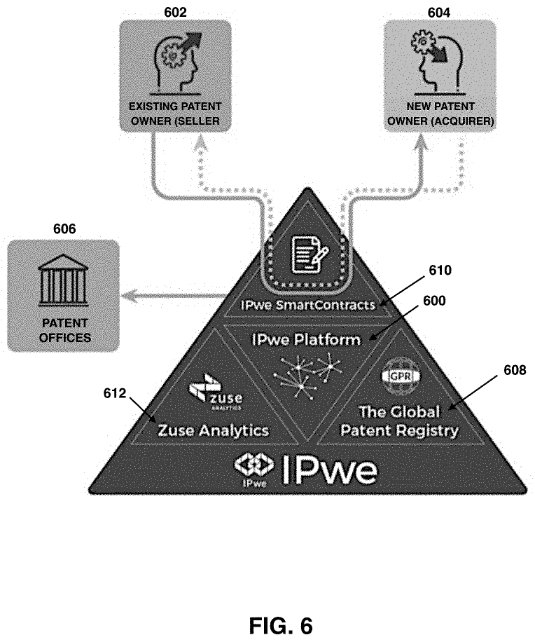

FIG. 6 is a diagram of patent sale and assignment transactions using the present invention. In accordance with the preferred embodiment of the present invention 600, the patent seller 602 sells patents to a patent acquirer 604 and receives funds from the patent sale. The patent office 606 then receives the assignment information and the global patent registry 608 is updated. The smart contracts 610 embodiment of the present invention 600 governs the identification of the patents and title updates, automatic execution of the sale including payments and reversions on default, the terms of agreement of sale, and whether the terms are made public. The present invention 600 then provides updates to the global patent registry 608, analysis of the sale 612, annuity payments, title verification, sale agreements and transactional support to the patent owner/seller 602.

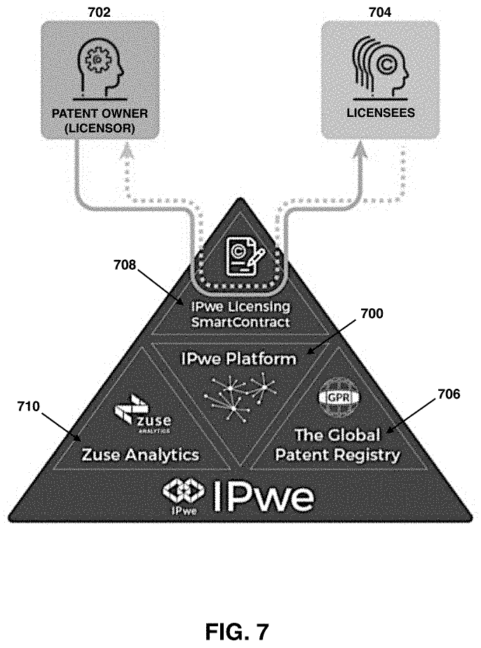

FIG. 7 is a diagram of patent licensing using the present invention. In accordance with the preferred embodiment of the present invention 700, the patent owner 702 licenses certain Licensees 704 under the selected patents. The Patent owner collects payments and royalties from the Licensees, and the licensing smart contracts embodiment 708 of the present invention is used to facilitate the identification of the patents, execution and payment of the license agreement, the terms of the license agreement, and whether any terms are made public. The present invention 700 provides an analysis 710, licensing agreements, title verification, reporting to the patent registry 706, annuity payments, royalty administration and transactional support to the patent owner 702.

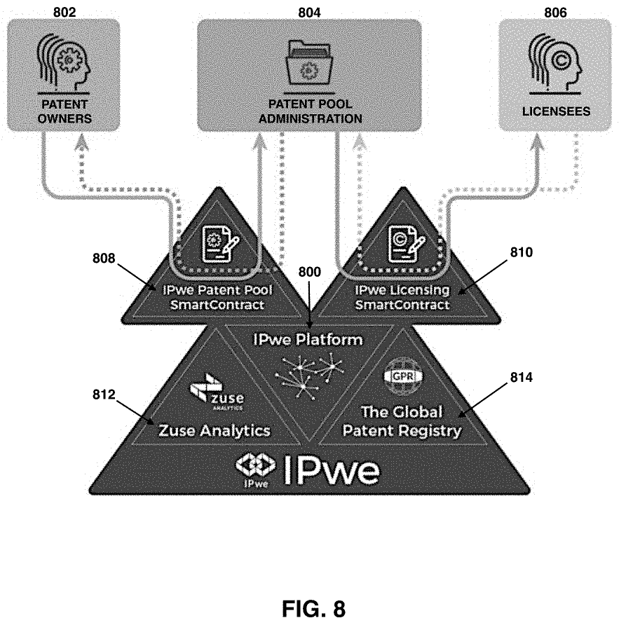

FIG. 8 is a diagram of the patent pooling process using the present invention. In accordance with the preferred embodiment of the present invention 800, patent owners 802 give licensing rights to the patent pool administration 804 and set the terms. The patent pool administration 804 grants licenses to licensees 806, collects royalties and redistributes those royalties to patent owners 802. The patent pool smart contracts embodiment 808 governs the identification of patents and parties, the terms of the license, and revenue share among patent owners. The licensing smart contracts embodiment 810 governs automatic execution and payments, identification of patents and parties, the terms of the license and whether terms are to be made public. The present invention 800 provides analytics 812, future tokenization opportunities, reporting to the global patent registry 814, royalty administration and transactional support.

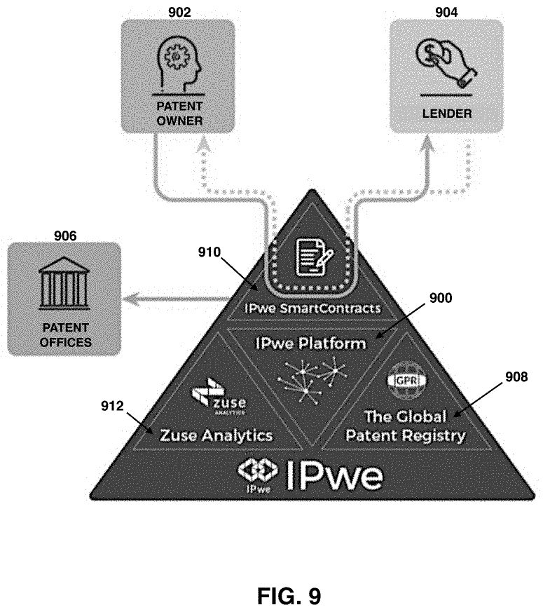

FIG. 9 is a diagram of the patent-based lending process of the present invention. In accordance with the preferred embodiment of the present invention 900, the patent owner 902 pledges patents to a lender 904. The patent owner 902 can then receive funds and reimburse the loan. The patent offices 906 are then informed about the pledge and release. The smart contracts 910 embodiment of the present invention 900 governs: the automatic execution and payment; identification of all patents and related parties; and the terms of the loan. The present invention 900 then provides updates to the global patent registry 908, analysis of the patent 912, future tokenization opportunities and transactional support to the patent owner 902 and lender 904.

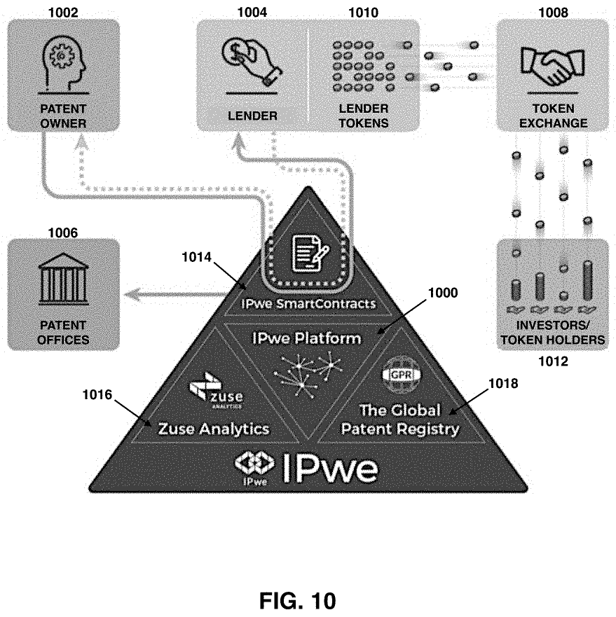

FIG. 10 is a diagram of tokenized patent-based lending using the present invention. In accordance with the preferred embodiment of the present invention 1000, the patent owner 1002 pledges patents to lenders 1004. The lenders then provide financing and the patent owner repays the loan. The patent office 1006 is informed about the pledge and release and the token exchange 1008 organizes the liquidity of the lender tokens 1010 among investors 1012. The smart contracts embodiment 1014 of the present invention 1000 governs the automatic execution and payment of the pledge, identification of all patents and parties involved in the transaction, the terms of the loan and the token holder's rights. The present invention 1000 provides analytics of the transaction 1016, pledge agreements, reporting to the global patent registry 1018, annuity payments, title verification, research and transactional support to the patent owner 1002 and the lender 1004.

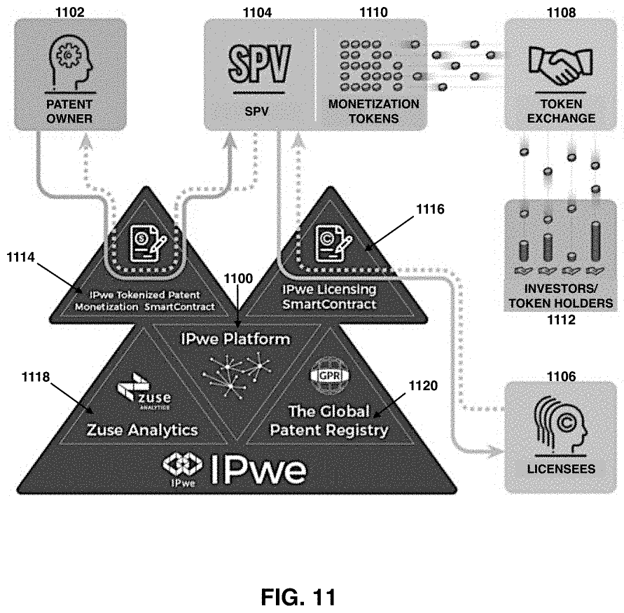

FIG. 11 is a diagram of tokenized patent monetization using the present invention. In accordance with the preferred embodiment of the present invention 1100, the patent owner transfers 1102 the ownership of selected patents to a Special Purpose Vehicle (“SPV”) 1104, and receives funds. The SPV 1104 sets rules of the licensing program to licensees 1106 and collects royalty payments. The token exchange 1108 organizes the liquidity of the monetization tokens 1110 among the investors/token holders 1112. The tokenization smart contract embodiment 1114 of the present invention 1100 governs the automatic execution and payment of the transaction, the identification of the patents and parties involved in the transaction and the investor/token holder's 1112 rights. The licensing smart contract embodiment 1116 of the present invention governs the automatic execution and payment of the transaction, the identification of the patents and parties involved in the transaction, the terms of the license and whether any terms are made public. The present invention 1100 provides analytics 1118 and transaction agreements, reporting of the transaction to the global patent registry 1120, annuity payments, title verification and royalty administration to the involved parties.

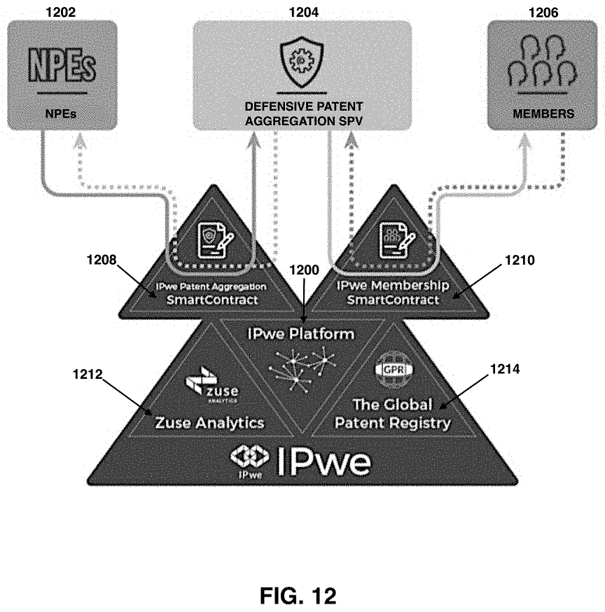

FIG. 12 is a diagram of patent defense aggregation using the present invention. In accordance with the preferred embodiment of the present invention 1200, Non-Practicing Entities (“NPEs”) 1202 sell patents or licensing rights to Defensive Patent Aggregation SPV 1204, which then grants licenses to members 1206 and collects membership fees and payments. The patent aggregation smart contracts embodiment 1208 governs automatic execution and payments, identification of patents and parties, and the terms of the patent sale or licensing rights. The membership smart contracts embodiment 1210 governs membership automatic execution and payments, member rights in the SPV, and the terms of membership. The present invention 1200 provides analytics 1212, reporting to the global patent registry 1214, royalty administration and transactional support.

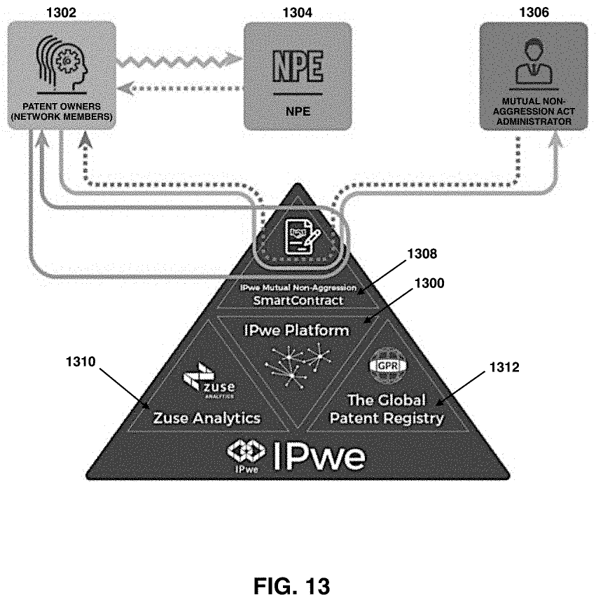

FIG. 13 is a diagram of the mutual non-aggression pact process of the present invention. In accordance with the preferred embodiment of the present invention 1300, patent owners 1302 commit to grant a license under their patents to all network members in case the patent owners sell patents to a Non-Practicing Entity (NPE) 1304. In the event of such a sale, licenses are granted to all network members 1302. The Mutual Non-Aggression Administrator 1306 promotes the network, facilitates pledges, and collects membership fees from network members 1302. The mutual non-aggression SmartContract embodiment 1308 of the present invention 1300 governs the triggering of a license to all network members under certain circumstances. The platform of the present invention 1300 provides an analysis of the transaction through the analytics embodiment 1310, reporting to the Global Patent Registry 1312, and transactional support to patent owners and network members 1302.

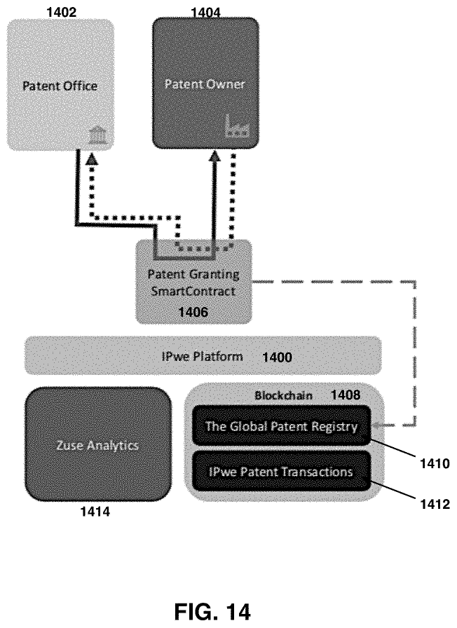

FIG. 14 is a diagram of the patent grant process of the present invention incorporating blockchain technology. In accordance with the preferred embodiment of the present invention 1400, communication between the patent office 1402 and the patent owner 1404 is enabled through the patent granting SmartContract feature 1406 of the present invention 1400. All information is processed using a blockchain system 1408, including updates made to the Global Patent Registry 1410, and all data related to patent transactions 1412. The platform of the present invention 1400 uses the data collected through blockchain 1408 from the Patent Registry 1410 and transactions 1412 to provide an analysis through the analytics embodiment 1414.

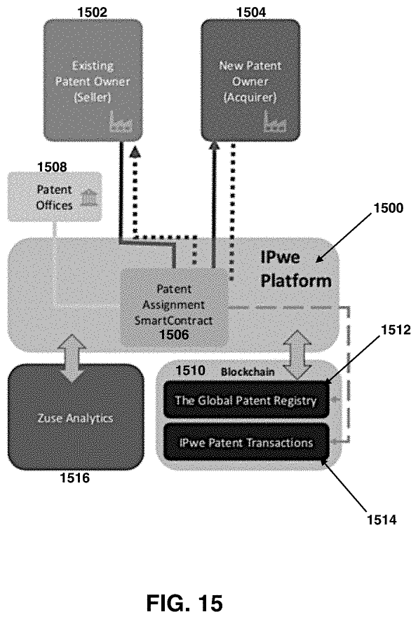

FIG. 15 is a diagram of the patent assignment process of the present invention incorporating blockchain technology. In accordance with the preferred embodiment of the present invention 1500, communication between the existing patent owner/seller 1502 and the new patent owner/acquirer 1504 is enabled through the patent assignment SmartContract feature 1506 of the present invention 1500. The SmartContract feature 1506 is also able to send and receive data of the sale to patent offices 1508. All information is processed using a blockchain system 1510, including updates made to the Global Patent Registry 1512, and all data related to patent transactions 1514. The platform of the present invention 1500 uses the data collected through blockchain 1510 from the Patent Registry 1512 and transactions 1514 to provide an analysis of the patent sale through the analytics embodiment 1516.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention. Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system. Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium. Any reference to “having”, “including” or “comprising” should be applied mutatis mutandis to “consisting” or “consisting essentially of.”

What is claimed is:

1. A network comprising a plurality of nodes, each node in the plurality of nodes configured to transact with at least one other node in the plurality of nodes, the network further comprising:
at least one hardware processor, a non-transitory machine-readable storage medium having an executable computer readable program code, the at least one hardware processor configured to execute the computer-readable program code to:
receive, by the secure ledger network, a request to validate a smart contract that determines at least one rule for a transaction involving the distribution of the virtual currency, wherein an execution of the transaction comprises:
receiving, by the secure ledger network, a request to approve an exchange rate for at least one virtual currency token in terms of FIAT currency;
validating the exchange rate;
updating a secure ledger maintained by the secure ledger network with the smart contract;
the smart contract further configured with at least one rule regarding the floating of the virtual currency;
executing a smart contract;
updating the secure ledger about the transaction; and
an evaluation engine, the engine capable of determining the value of an intellectual property asset in terms of virtual currency, said evaluation engine configured to update the smart contract regarding the value of the IP asset in terms of virtual currency, and wherein patent ownership is verified based on records obtained from either a national patent office, from a national patent office confirmed by predictive analytics or from analysis as confirmed by a patent owner.
